(19) United States
(12) Patent Application Publication
(10) Pub. No.: US 2023/0103756 A1
(43) Pub. Date: Apr. 6, 2023

(54) Low Emission Glass Fiber Reinforced Propylene Polymer Composition

(71) Applicant: Celanese International Corporation, Irving, TX (US)

(72) Inventor: Riccardo Savadori, Ferrara (IT)

(21) Appl. No.: 17/953,393

(22) Filed: Sep. 27, 2022

Related U.S. Application Data
(60) Provisional application No. 63/251,185, filed on Oct. 1, 2021.

(51) Int. Cl. C08L 23/12

(52) U.S. Cl. CPC C08L 23/12

(57) ABSTRACT

A propylene polymer composition is provided. The propylene polymer composition comprises a metallocene-catalyzed propylene homopolymer, from about 15 wt. % to about 60 wt. % of glass fibers having an average fiber length of about 4.5 mm or less, and a compatibilizer comprising a functionalized polyolefin. The propylene polymer composition exhibits a fogging value of about 0.6 mg or less as determined according to DIN 75201:2011 (method B). The composition also exhibits a flexural modulus of about 4,000 MPa or more as determined at a temperature of about 23° C. by ISO 527:2019.

### RELATED APPLICATION

The present application is based upon and claims priority to U.S. Provisional Patent Application Ser. No. 63/251,185, having a filing date of Oct. 1, 2021, which is incorporated herein by reference.

### BACKGROUND OF THE INVENTION

Polypropylene-based compositions are routinely used to fabricate various types of interior and exterior automotive parts (e.g., dashboard skins, airbag covers, bumper covers, exterior fascia, air dams and other trim pieces). There is an increasing need in the automotive industry for propylene-based compositions to have low emission properties for both interior parts and exterior parts, such as headlamp housings with good optics. However, low emission polypropylene compositions tend to have poor mechanical properties. As such, a need currently exists for a propylene composition that has low emission properties and desirable mechanical properties.

### SUMMARY OF THE INVENTION

In accordance with one embodiment of the present invention, a propylene polymer composition is disclosed that comprises a metallocene-catalyzed propylene homopolymer, from about 15 wt. % to about 60 wt. % of glass fibers having an average fiber length of about 4.5 mm or less, and a compatibilizer comprising a functionalized polyolefin. The propylene polymer composition exhibits a fogging value of about 0.6 mg or less as determined according to DIN 75201:2011 (method B). The composition also exhibits a flexural modulus of about 4,000 MPa or more as determined at a temperature of about 23° C. by ISO 527:2019.

Other features and aspects of the present invention are set forth in greater detail below.

### DETAILED DESCRIPTION OF REPRESENTATIVE EMBODIMENTS

It is to be understood by one of ordinary skill in the art that the present discussion is a description of exemplary embodiments only, and is not intended as limiting the broader aspects of the present invention.

Generally speaking, the present invention is directed to a polymer composition for use in forming shaped parts (e.g., injection molded parts) for automotive applications. The polymer composition contains at least one metallocene-catalyzed propylene homopolymer, glass fibers, and a compatibilizer. The composition has excellent low emission properties. For example, the composition exhibits a fogging value of about 0.6 mg or less, in some embodiments about 0.5 mg or less, in some embodiments, about 0.3 or less, and in some embodiments, from about 0.05 to about 0.2 mg, as determined according to DIN 75201:2011 (method B). In addition to low fogging properties, the polymer composition can also possess additional properties related to low emissions. For example, the polymer composition may exhibit a total volatile content (“VOC”) of about 50 micrograms equivalent carbon per gram of the composition (“μgC/g”) or less, in some embodiments about 20 μg/g or less, in some embodiments about 15 μg/g or less, in some embodiments about 10 μg/g or less, in some embodiments about 8 μg/g or less, and in some embodiments, from about 1 μg/g to about about 6 μg/g as determined in accordance with VDA 277:1995. The composition may also exhibit a toluene equivalent volatile content (“TVOC”) of about 100 micrograms equivalent toluene per gram of the composition (“μg/g”) or less, in some embodiments about 80 μg/g or less, in some embodiments about 70 μg/g or less, in some embodiments about 30 μg/g or less, and in some embodiments, from about 5 μg/g to about 20 μg/g, as well as a fogging content (“FOG”) of about 500 micrograms hexadecane per gram of the composition (“μg/g”) or less, in some embodiments about 300 μg/g or less, in some embodiments about 100 μg/g or less, and in some embodiments, from about 25 to about 75 μg/g, each of which may be determined in accordance with VDA 278:2002.

Conventionally, it was believed that compositions with such a low fogging value could not achieve sufficiently good mechanical properties for use in automotive applications. Nevertheless, even with such low emission properties, the present inventors have discovered that the resulting composition can achieve good mechanical properties through selective control over the particular nature and/or concentration of the propylene polymer, glass fibers, and the compatibilizer, as well as other optional components. For example, the polymer composition generally exhibits a flexural modulus of about 4,000 MPa or more, in some embodiments from about 4,250 MPa to about 19,000 MPa, in some embodiments from about 5,000 MPa to about 20,000 MPa, in some embodiments from about 6,000 MPa to about 18,000 MPa, in some embodiments about 7,000 MPa to about 15,000 MPa, in some embodiments from about 8,000 MPa to about 14,000 MPa, and in some embodiments, about 9,000 MPa to about 12,000 MPa. The polymer composition may also exhibit a maximum flexural stress of about 25 MPa or more, in some embodiments from about 50 to about 200 MPa, in some embodiments from about 100 to about 175 MPa, and in some embodiments, from about 140 to about 170 MPa. The flexural properties may be determined in accordance with ISO Test No. 178:2019 at 23° C. The tensile mechanical properties may also be good. For example, the composition may exhibit a tensile strength at yield of about 25 or more, in some embodiments about 50 MPa or more, in some embodiments from about 60 MPa to about 150 MPa, in some embodiments from about 65 to about 120 MPa, in some embodiments from about 70 to about 110 MPa, and in some embodiments, from about 80 to about 100 MPa; an elongation at break of about 1% or more, in some embodiments about 2% or more, in some embodiments about 2.5% to about 5%, and in some embodiments, from about 2.6% to about 4.5%; and/or a tensile modulus of about 2,000 MPa or more, in some embodiments about 4,000 MPa to about 15,000 MPa, in some embodiments from about 6,000 MPa to about 12,000 MPa, and in some embodiments, from about 6,500 MPa to about 10,000 MPa. The tensile properties may be determined in accordance with ISO Test No. 527-1:2019 at 23° C.

The composition may also exhibit a Charpy notched impact strength of about 2 kJ/m² or more, in some embodiments from about 7 kJ/m² to about 40 kJ/m², in some embodiments from about 8 kJ/m² to about 30 kJ/m², in some embodiments from about 9 kJ/m² to about 25 kJ/m², and in some embodiments, from about 10 kJ/m² to about 15 kJ/m², measured at 23° C. according to ISO Test No. 179-1:2010. The composition may also exhibit a Charpy unnotched impact strength of about 10 kJ/m² or more, in some embodiments about 30 KJ/m² or more, in some embodiments from about 45 to about 100 kJ/m², and in some embodiments, from about 50 to about 90 kJ/m², measured at 23° C. according to ISO Test No. 179-1:2010 (technically equivalent to ASTM D256-10e1). The polymer composition may also exhibit a deflection temperature under load (DTUL) of about 100° C. or more, in some embodiments from about 125° C. to about 160° C., and in some embodiments, from about 140° C. to about 150° C. as determined in accordance with ISO 75-2:2013 (technically equivalent to ASTM D648-07) at a specified load of 1.8 MPa. The polymer composition may also possess good olfactory characteristics. For example, the composition may exhibit an odor value of about 4 or less and in some embodiments, from about 2 to 3.5, as determined by VDA 270:2018.

The present inventors have also discovered that the polymer composition has good thermal stability. For example, the polymer composition can resist becoming brittle when exposed to high temperatures for extended periods of time. Particularly, the time to brittling of the polymer composition, defined as the time it takes for the elongation at break to become 1% or less when exposed to heat at 150° C. in an air circulating oven, may be about 500 hours or longer, in some embodiments about 900 hours or longer, in some embodiments about 1,000 hours or longer, and in some embodiments, from about 1,200 hours to about 3,000 hours. Additionally, the elongation at break of the polymer composition after heat aging at 150° C. for 1000 hours can be about 50% of the elongation at break of the polymer composition prior to heat aging or greater, in some embodiments about 60% or greater, and in some embodiments, from about 70% to about 95%.

Various embodiments of the present invention will now be described in more detail.

### I. Polymer Composition

A. Propylene Homopolymer

As noted, the polymer composition contains at least one propylene homopolymer synthesized using a metallocene catalyst. Metallocene-catalyzed propylene homopolymers typically constitute from about 20 wt. % to about 80 wt. %, in some embodiments from about 30 wt. % to about 75 wt. %, and in some embodiments, from about 50 wt. % to about 70 wt. % of the polymer composition. In some embodiments, all propylene homopolymers contained in the composition are metallocene-catalyzed. However, in other embodiments, non-metallocene-catalyzed propylene homopolymers or copolymers are also contained in the composition. For example, the composition may also contain propylene polymers prepared in other ways, such as by Ziegler-Natta type catalysts. When employed, non-metallocene catalyzed propylene polymers typically make up less than about 75 wt. % of the propylene polymers in the composition, in some embodiments less than about 50 wt. %, in some embodiments less than about 35 wt. %, and in some embodiments, less than about 30 wt. % of the propylene polymers in the composition. For example, in some embodiments, non-metallocene-catalyzed propylene homopolymers constitute no more than 20 wt. % of the polymer composition and in some embodiments no more than 15 wt. % of the composition.

In one embodiment, the propylene polymer may be an isotactic or syndiotactic homopolymer. The term “syndiotactic” generally refers to a tacticity in which a substantial portion, if not all, of the methyl groups alternate on opposite sides along the polymer chain. On the other hand, the term “isotactic” generally refers to a tacticity in which a substantial portion, if not all, of the methyl groups are on the same side along the polymer chain. The metallocene-catalyzed propylene homopolymer may have a relatively low melting point. For example, the metallocene-catalyzed propylene homopolymer can have a melting point of less than about 160° C., in some embodiments less than about 155° C., and in some embodiments, from about 145° C. to about 153° C.

In some embodiments, the metallocene catalyzed-propylene homopolymer is isotactic. For example, the polymer can have an mmmm pentad content of at least about 93%, in some embodiments about 95% or greater, and in some embodiments, from about 97% to about 99%. The isotacticity can be determined by NMR analysis according to the method described by G. J. Ray et al. in Macromolecules, vol. 10, no 4, 1977, p. 773-778.

The metallocene-catalyzed propylene homopolymer can have a crystallinity from about 35% to about 70%, in some embodiments from about 40% to about 60%, and in some embodiments, from about 45% to about 55%. Crystallinity is measured on the basis of DSC results by using the following equation, % crystallinity=ΔHf/ΔHf*, where ΔHf and ΔHf* refer to the melting enthalpies of the resins and propylene homopolymers with 100% crystallinity.

The crystallization temperature of the metallocene-catalyzed propylene homopolymer can be from about 100° C. to about 135° C., in some embodiments from about 105° C. to about 125° C., and in some embodiments, from about 107° C. to about 115° C. Crystallization temperature can be determined by DSC analysis using a heating and cooling rate of 20° C./min after erasing thermal history by heating to 200° C. and maintaining the temperature for 3 minutes.

Metallocene-catalyzed propylene homopolymers typically emit fewer organic compounds than Ziegler-Natta catalyzed polypropylenes. Examples of metallocene catalysts include bis(n-butylcyclopentadienyl)titanium dichloride, bis(n-butylcyclopentadienyl)zirconium dichloride, bis(cyclopentadienyl)scandium chloride, bis(indenyl)zirconium dichloride, bis(methylcyclopentadienyl)titanium dichloride, bis(methylcyclopentadienyl)zirconium dichloride, cobaltocene, cyclopentadienyltitanium trichloride, ferrocene, hafnocene dichloride, isopropyl(cyclopentadienyl-1-flourenyl)zirconium dichloride, molybdocene dichloride, nickelocene, niobocene dichloride, ruthenocene, titanocene dichloride, zirconocene chloride hydride, zirconocene dichloride, and the like. Polymers made using metallocene catalysts typically have a narrow molecular weight range, controlled short chain branching distribution, and controlled isotacticity. For example, the metallocene-catalyzed propylene homopolymer may have a narrow molecular weight distribution (Mw/Mn) of less than about 5.0, in some embodiments less than about 4.0, in some embodiments less than about 3.5, and in some embodiments, from about 1.5 to about 3.0.

The metallocene catalyzed-propylene homopolymer may exhibit a flexural modulus of about 800 MPa or greater, in some embodiments, from about 1,000 MPa or greater, and in some embodiments, from about 1,200 MPa to about 2,000 MPa. At least one propylene polymer contained in the composition may have a relatively low melt flow rate, such as about 50 grams per 10 minutes or less, in some embodiments about 30 grams per 10 minutes or less, and in some embodiments, from about 0.5 to about 15 grams per 10 minutes, as determined in accordance with ISO 1133-1:2011 (technically equivalent to ASTM D1238-13) at a load of 2.16 kg and temperature of 230° C. In some embodiments, the polymer composition may include a propylene polymer with a relatively low melt flow index in combination with a propylene homopolymer with a relatively high melt flow index, such as about 55 grams per 10 minutes or more, in some embodiments about 100 grams per 10 minutes or more, and in some embodiments, from about 140 grams per 10 minutes to about 250 grams per 10 minutes, as determined in accordance with ISO 1133-1:2011 (technically equivalent to ASTM D1238-13) at a load of 2.16 kg and temperature of 230° C. For example, in some embodiments, the composition contains a ratio of low melt flow propylene homopolymers to high melt flow propylene homopolymers of from about 1:5 to about 5:1, in some embodiments from about 1:4 to about 2:1, and in some embodiments, from about 1:3 to about 3:2. When employed, the high flow propylene polymer is preferably metallocene-catalyzed. Additionally, in some embodiments, the polymer composition contains a low percentage of non-metallocene-catalyzed propylene polymers having a crystallinity of 70% or more as determined by DSC, as the present inventors found that compositions containing highly crystalline propylene homopolymers can have higher fogging values and emissions in general. For example, in some embodiments non-metallocene-catalyzed propylene polymers having a crystallinity of 70% or greater constitute no more than about 15 wt. % of the composition, in some embodiments no more than about 10 wt. % of the composition, and in some embodiments from 0 wt. % to about 5 wt. % of the composition.

B. Glass Fibers

Glass fibers are also employed in the polymer composition of the present invention. The present inventors found that the use of glass fibers of certain lengths and in certain concentrations can provide the composition with good mechanical properties and low emission properties. For example, the glass fibers generally have a length of about 4.5 mm or less, in some embodiments, about 4.0 mm or less, and in some embodiments, from about 0.5 to about 3.5 mm. Such fibers are generally referred to as chopped strands. As used herein, the length of the glass fibers refers to the length of the fibers before compounding the polymer composition. The length of the fibers may decrease when the composition is processed. The diameter of the glass fibers is typically from about 5 to about 25 μm, in some embodiments, from about 9 to about 20 μm, and in some embodiments, from about 11 to about 15 μm. Suitable glass fibers include E-glass, A-glass, C-glass, D-glass, AR-glass, R-glass, S1-glass, S2-glass, etc., and mixtures thereof.

In some embodiments, the glass fibers may be provided with a sizing to protect the glass fiber, smooth the fiber, and to improve the adhesion between the fiber and the polypropylene matrix. For example, the sizing may enhance the adhesion between the glass fibers and polypropylene provided by the compatibilizer. If present, a sizing may comprise silanes, film forming agents, lubricants, wetting agents, adhesive agents optionally antistatic agents and plasticizers, emulsifiers and optionally further additives. In one particular embodiment, the sizing may include a silane. Specific examples of silanes are aminosilanes, e.g., 3-trimethoxysilylpropylamine, N-(2-aminoethyl)-3-aminopropyltrimethoxy-silane, N-(3-trimethoxysilanylpropyl)ethane-1,2-diamine, 3-(2-aminoethyl-amino)propyltrimethoxysilane, N-[3-(trimethoxysilyl)propyl]-1,2-ethane-diamine.

Glass fibers generally constitute from about 15 wt. % to about 60 wt. %, in some embodiments from about 20 wt. % to about 50 wt. %, and in some embodiments, from about 30 wt. % to about 40 wt. % of the polymer composition.

C. Compatibilizer

A compatibilizer is employed in the polymer composition to enhance the degree of adhesion between the glass fibers and the propylene polymer(s). Compatibilizers typically constitute from about 0.1 wt. % to about 15 wt. %, in some embodiments from about 0.5 wt. % to about 10 wt. %, and in some embodiments, from about 0.9 wt. % to about 5 wt. % of the polymer composition. The compatibilizer may be a polyolefin compatibilizer that contains a polyolefin that is modified with a functional group. The polyolefin may be an olefin homopolymer (e.g., polypropylene) or copolymer (e.g., ethylene copolymer, propylene copolymer, etc.). The functional group may be grafted onto the polyolefin backbone or incorporated as a monomeric constituent of the polymer (e.g., block or random copolymers), etc. Particularly suitable functional groups include maleic anhydride, maleic acid, fumaric acid, maleimide, maleic acid hydrazide, a reaction product of maleic anhydride and diamine, methylnadic anhydride, dichloromaleic anhydride, maleic acid amide, etc. For example, in one embodiment, the compatibilizer comprises a maleic anhydride grafted polypropylene.

The functional group typically constitutes less than about 10 wt. % of the compatibilizer. For example, in some embodiments the functional group constitutes less than about 5 wt. %, of the compatibilizer, in some embodiments from about 0.1 wt. % to about 3 wt. %, of the compatibilizer, and in some embodiments, from about 0.5 wt. % to about 2 wt. % of the compatibilizer.

In some embodiments, the compatibilizer has a melt flow rate from about 10 g/10 min to about 200 g/10 min, in some embodiments from about 25 g/10 min to about 150 g/10 min, and in some embodiments, from about 50 g/10 min to about 125 g/10 min, as determined in accordance with ISO 1133-1:2011 (technically equivalent to ASTM D1238-13) at a load of 2.16 kg and temperature of 190° C.

D. Optional Components

In addition to the propylene polymer, glass fibers, and compatibilizer, a variety of other components may optionally be employed in the polymer composition. Examples of such optional components may include, for instance, stabilizers (e.g., light stabilizers, heat stabilizers, etc.), antioxidants (e.g., phosphite, phenolic, thioester, etc.), particulate fillers, lubricants (e.g., polyethylene wax, fatty acid esters/amides, etc.), pigments (e.g., carbon black, laser marking, titanium dioxide), flow modifiers, and other materials added to enhance properties and processability.

In certain embodiments, particulate fillers (e.g., mineral fillers) may also be employed in the polymer composition. For example, clay minerals may be employed, such as talc, halloysite, kaolinite, illite, montmorillonite, vermiculite, palygorskite, pyrophyllite, etc., as well as combinations thereof. In lieu of, or in addition to, clay minerals, still other particulate fillers may also be employed. For example, other suitable silicate fillers may also be employed, such as calcium silicate, aluminum silicate, mica, diatomaceous earth, wollastonite, and so forth. Despite the fact that such fillers can optionally be employed, the present inventors have nevertheless discovered that the improved mechanical properties can be achieved without the presence of a substantial amount of particulate fillers (e.g., mineral fillers). For example, the polymer composition may contain only a relatively small percentage, if any, of particulate fillers, such as no more than about 5 wt. %, in some embodiments no more than about 3 wt. %, and in some embodiments, from 0 wt. % to about 2 wt. % (e.g., 0 wt. %) of the polymer composition.

The polymer composition may also contain an odor masking agent, for example, to reduce odor when used in an interior automotive part. The odor masking agent, for instance, can absorb odors and/or produce its own odor. Masking agents that may be incorporated into the composition include zeolites, particularly synthetic zeolites, fragrances, and the like.

The polymer composition may also contain additional polymers, such as other poly α-olefin polymers. For example, in one embodiment, the composition contains a polyethylene copolymer, such as LLDPE. Such additional polymers may be used as carriers for other optional components, such as pigments.

### II. Method for Forming the Polymer Composition

The manner in which the constituents of the composition are combined may vary as is known in the art. For instance, the raw materials may be supplied either simultaneously or in sequence to a melt processing device that dispersively blends the materials. Batch and/or continuous melt processing techniques may be employed. For example, a mixer/kneader, Banbury mixer, Farrel continuous mixer, single-screw extruder, twin-screw extruder, roll mill, etc., may be utilized to blend and melt process the materials. One particularly suitable melt processing device is a co-rotating, twin-screw extruder (e.g., Leistritz co-rotating fully intermeshing twin screw extruder). Such extruders may include feeding and venting ports and provide high intensity distributive and dispersive mixing. For example, the propylene polymer, glass fibers, and compatibilizer may be fed to the same or different feeding ports of a twin-screw extruder and melt blended to form a substantially homogeneous melted mixture. Melt blending may occur under high shear/pressure and heat to ensure sufficient dispersion. For example, melt processing may occur at a temperature of from about 100° C. to about 260° C., and in some embodiments, from about 120° C. to about 220° C. Likewise, the shear rate during melt processing may range from about 100 seconds⁻¹ to about 10,000 seconds⁻¹, and in some embodiments, from about 500 seconds⁻¹ to about 1,500 seconds⁻¹. Of course, other variables, such as the residence time during melt processing, which is inversely proportional to throughput rate, may also be controlled to achieve the desired degree of homogeneity.

The resulting polymer composition typically has a melting temperature of from about 100° C. to about 300° C., in some embodiments from about 120° C. to about 250° C., and in some embodiments, from about 150° C. to about 220° C., such as determined by ISO Test No. 11357:2013. The polymer composition may also have a relatively low melt flow index, such as about 50 grams per 10 minutes or less, in some embodiments about 20 grams per 10 minutes or less, and in some embodiments, from about 1 to about 15 grams per 10 minutes, as determined in accordance with ISO 1133-1:2011 (technically equivalent to ASTM D1238-13) at a load of 2.16 kg and temperature of 230° C.

### III. Shaped Parts

Shaped parts may be formed from the polymer composition having a wide variety of thicknesses, such as about 20 millimeters or less, in some embodiments about 10 millimeters or less, in some embodiments about 5 millimeters or less, in some embodiments about 4 millimeters or less. The shaped part may be formed using a variety of different techniques. Suitable techniques may include, for instance, injection molding, low-pressure injection molding, extrusion compression molding, gas injection molding, foam injection molding, low-pressure gas injection molding, low-pressure foam injection molding, gas extrusion compression molding, foam extrusion compression molding, extrusion molding, foam extrusion molding, compression molding, foam compression molding, gas compression molding, etc. For example, an injection molding system may be employed that includes a mold within which the polymer composition may be injected. The time inside the injector may be controlled and optimized so that polymer composition is not pre-solidified. When the cycle time is reached and the barrel is full for discharge, a piston may be used to inject the composition to the mold cavity. Compression molding systems may also be employed. As with injection molding, the shaping of the polymer composition into the desired article also occurs within a mold. The composition may be placed into the compression mold using any known technique, such as by being picked up by an automated robot arm. The temperature of the mold may be maintained at or above the solidification temperature of the polymer matrix for a desired time period to allow for solidification. The molded product may then be solidified by bringing it to a temperature below that of the melting temperature. The resulting product may be de-molded. The cycle time for each molding process may be adjusted to suit the polymer composition, to achieve sufficient bonding, and to enhance overall process productivity.

Regardless of the shaping technique employed, a wide variety of parts may be formed from the polymer composition of the present invention. For example, the present inventors have discovered that the polymer composition is particularly suitable for use in interior and exterior automotive parts (e.g., injection molded parts). Suitable exterior automotive parts may include headlamp housings, fan shrouds, sunroof systems, door panels, front end modules, side body panels, underbody shields, bumper panels, cladding (e.g., near the rear door license plate), cowls, spray nozzle body, capturing hose assembly, pillar cover, rocker panel, etc. Likewise, suitable interior automotive parts that may be formed from the polymer composition of the present invention may include, for instance, pedal modules, instrument panels (e.g., dashboards), arm rests, consoles (e.g., center consoles), seat structures (e.g., backrest of the rear bench or seat covers), interior modules (e.g., trim, body panel, or door module), lift gates, interior organizers, step assists, ash trays, glove boxes, gear shift levers, etc.

The present invention may be better understood with reference to the following examples.

### Test Methods

Melt Flow Index: The melt flow index of a polymer or polymer composition may be determined in accordance with ISO 1133-1:2011 (technically equivalent to ASTM D1238-13) at a load of 2.16 kg, 5 kg or 10 kg and a temperature of 230° C. or 190° C.

Tensile Modulus, Tensile Strength at Yield, Tensile Elongation at Yield, Tensile Strength at Break, and Tensile Elongation at Break: Tensile properties may be tested according to ISO Test No. 527-1:2019 (technically equivalent to ASTM D638-14). Modulus and strength measurements may be made on the same test strip sample having a length of 80 mm, width of 10 mm, and thickness of 4 mm. The testing temperature may be 23° C., 60° C., 80° C., 100° C., 120° C., −20° C., −30° C., or −40° C., and the testing speed may be 1, 2, 5, or 50 mm/min.

Flexural Modulus and Maximum Flexural Stress: Flexural properties may be tested according to ISO Test No. 178:2019 (technically equivalent to ASTM D790-15e2). This test may be performed on a 64 mm support span. Tests may be run on the center portions of uncut ISO 3167 multi-purpose bars. The testing temperature may be 23° C., 60° C., 80° C., 100° C., 120° C., −20° C., −30° C., or −40° C., and the testing speed may be 1, 2, or 5 mm/min.

Unnotched and Notched Charpy Impact Strength: Charpy properties may be tested according to ISO Test No. ISO 179-1:2010) (technically equivalent to ASTM D256-10e1, Method B). This test may be run using a Type 1 specimen size (length of 80 mm, width of 10 mm, and thickness of 4 mm). When testing the notched impact strength, the notch may be a Type A notch (0.25 mm base radius). Specimens may be cut from the center of a multi-purpose bar using a single tooth milling machine. The testing temperature may be 23° C., −20° C., −30° C., or −40° C.

Izod Notched Impact Strength: Notched Izod properties may be tested according to ISO Test No. 180:2000 (technically equivalent to ASTM D256-10e1, Method A). This test may be run using a Type 1 specimen size (length of 80 mm, width of 10 mm, and thickness of 4 mm). When testing the notched impact strength, the notch may be a Type A notch (0.25 mm base radius). Specimens may be cut from the center of a multi-purpose bar using a single tooth milling machine. The testing temperature may be 23° C., −20° C., −30° C., or −40° C.

Deflection Temperature Under Load (“DTUL”): The deflection under load temperature may be determined in accordance with ISO Test No. 75-2:2013 (technically equivalent to ASTM D648-07). More particularly, a test strip sample having a length of 80 mm, thickness of 10 mm, and width of 4 mm may be subjected to an edgewise three-point bending test in which the specified load (maximum outer fibers stress) was 1.8 Megapascals. The specimen may be lowered into a silicone oil bath where the temperature is raised at 2° C. per minute until it deflects 0.25 mm (0.32 mm for ISO Test No. 75-2:2013).

Volatile Organic Content (“VOC”): The total volatile organic content may be determined in accordance with an automotive industry standard test known as VDA 277:1995. In this test, for instance, a gas chromatography (GC) device may be employed with a WCOT-capillary column (wax type) of 0.25 mm inner diameter and 30 m length. The GC settings may be as follows: 3 minutes isothermal at 50° C., heat up to 200° C. at 12 K/min, 4 minutes isothermal at 200° C., injection-temperature of 200° C., detection-temperature of 250° C., carrier is helium, flow-mode split of 1:20 and average carrier-speed of 22-27 cm/s. A flame ionization detector (“FID”) may be employed to determine the total volatile content and a mass spectrometry (“MS”) detector may also be optionally employed to determine single volatile components. After testing, the VOC amount is calculated by dividing the amount of volatiles (micrograms of carbon equivalents) by the weight (grams) of the composition.

Toluene Volatile Organic Content (“TVOC”): The toluene-equivalent volatile organic content may be determined in accordance with an automotive industry standard test known as VDA 278:2002. More particularly, measurements may be made on a sample using a thermaldesoprtion analyzer (“TDSA”), such as supplied by Gerstel using helium 5.0 as carrier gas and a column HP Ultra 2 of 50 m length and 0.32 mm diameter and 0.52 μm coating of 5% phenylmethylsiloxane. The analysis may, for example, be performed using device setting 1 and the following parameters: flow mode of splitless, final temperature of 90° C.; final time of 30 min, and rate of 60 K/min. The cooling trap may be purged with a flow-mode split of 1:30 in a temperature range from −150° C. to +280° C. with a heating rate of 12 K/sec and a final time of 5 min. For analysis, the gas chromatography (“GC”) settings may be 2 min isothermal at 40° C., heating at 3 K/min up to 92° C., then at 5 K/min up to 160° C., and then at 10 K/min up to 280° C., 10 minutes isothermal, and flow of 1.3 ml/min. After testing, the TVOC amount is calculated by dividing the amount of volatiles (micrograms of toluene equivalents) by the weight (grams) of the composition.

Fogging Content (“FOG”): The fogging content may be determined in accordance with an automotive industry standard test known as VDA 278:2002. More particularly, measurements may be made on a sample using a thermaldesoprtion analyzer (“TDSA”), such as supplied by Gerstel using helium 5.0 as carrier gas and a column HP Ultra 2 of 50 m length and 0.32 mm diameter and 0.52 μm coating of 5% phenylmethylsiloxane. The analysis may, for example, be performed using device setting 1 and the following parameters: flow mode of splitless, final temperature of 120° C.; final time of 60 min, and rate of 60 K/min. The cooling trap may be purged with a flow-mode split of 1:30 in a temperature range from −150° C. to +280° C. with a heating rate of 12 K/sec. For analysis, the gas chromatography (“GC”) settings may be 2 min isothermal at 50° C., heating at 25 K/min up to 160° C., then at 10 K/min up to 280° C., 30 minutes isothermal, and flow of 1.3 ml/min. After testing, the FOG amount is calculated by dividing the amount of volatiles (micrograms of hexadecane equivalents) by the weight (grams) of the composition.

Fogging Value—Gravimetric: Fogging is measured according to DIN 75201:2011, method B on molded specimens (diameter 80 mm+/−1 mm, thickness 2 mm) cut out from an injection molded plate. Method B evaluates the volatility of organic constituents by gravimetric measurements. The samples are dried at room temperature for 24 h using silica gel in a desiccator. The test is performed at 100° C. The molded specimen is placed in a beaker which is closed using tared aluminum foils (diameter 103 mm, thickness 0.03 mm) with cooled glass plates on top. After the testing time (16 h at 100° C.) the glass plates are removed and the aluminum foils are removed and weighed. The gravimetric fogging value is be determined by the following equation:

G=weight of aluminum foil after fogging test−tare of the aluminum foil, in mg.
G sample=Average in mg of the 2 foils used for each sample.

Fogging Value—Reflectometric: Fogging is measured according to DIN 75201:2011, method A. Specifically, a beaker containing a molded part containing the composition is immersed in an oil bath of 100° C. A glass plate cooled to 21° C. is placed on the upper surface of the beaker. After standing for 3 hours in such a state, the glass plate is taken out and the reflection rate (%) of the surface at the inner side of the glass plate using light at a 60° incident angle is determined [60° incident reflection rate (%) of glass plate after test=intensity of incident light to glass plate after test/intensity of reflection light at the time when incident light enters glass plate after test×100]. Then, using the following expression, a fogging test reflection rate (%) is calculated:

Fogging test reflection rate (%)=[60° incident reflection rate of glass plate after test (%)/60° incident reflection rate of glass plate before test (%)]×100.

### Example 1

A sample was formed containing 55.00 wt. % of a metallocene-catalyzed homopolymer having a melt flow index of 20 grams per 10 minutes, 21.95 wt. % of a non-metallocene-catalyzed propylene homopolymer having a melt flow index of 0.91 grams per 10 minutes, 20.00 wt. % of glass fibers having an average length of 4 mm and an average diameter of 13 μm, 1.70 wt. % of a maleic anhydride modified polypropylene homopolymer, 0.30 wt. % of a laser marking pigment, 0.20 wt. % of antioxidant 1010, 0.20 wt. % of antioxidant 168, 0.20 wt. % of a thioester antioxidant, 0.20 wt. % of polyethylene wax, and 0.25 wt. % of a black polyethylene masterbatch.

The sample was tested for its mechanical properties and emission characteristics, which are provided in Table 1.

TABLE 1

| Characteristic | Unit | Sample 1 |
|---|---|---|
| Melt Flow Rate | g/10 min | 5.3 |
| Tensile Modulus | MPa | 4618 |
| Tensile Strength at yield | MPa | 62 |
| Elongation at yield | % | 3.3 |
| Tensile Strength at | MPa | 60.1 |
| break | | |
| Elongation at break | % | 4.4 |
| Flexural Modulus | MPa | 4293 |
| Maximum Flexural | MPa | 101 |
| Stress | | |
| Charpy Notched | kJ/m² | 8 |
| Charpy Unnotched | kJ/m² | 46.7 |
| HDT 1.8 | ° C. | 126 |
| Fogging (DIN 75201-B) | mg | 0.38 |
| Odor - B3 (VDA 270) | — | 3 |
| VOC (VDA 277) | μgC/g | 5 |

Sample 1 was then aged at 150° C. for 1000 hours and tested for its tensile properties. After performing the tensile tests, the sample was aged until it became brittle. The results of these tensile tests and the time to brittling are provided in Table 2.

TABLE 2

| Characteristic | Unit | Sample 1 |
|---|---|---|
| Tensile Modulus | MPa | 5495 |
| Tensile Strength at | MPa | 72.5 |
| break | | |
| Elongation at break | % | 2.5 |
| Time to Brittling | h | 1100 |

### Examples 2-9

Samples 2-9 were formed using metallocene catalyzed polypropylene homopolymers, glass fibers, compatibilizers, and various other components as indicated in Table 3. The glass fibers contained in Samples 2-9 had an average length of 4 mm and an average diameter of 13 μm. The samples were prepared in the same manner as described in Example 1.

TABLE 3

| | Sample | Sample | Sample | Sample | Sample | Sample | Sample | Sample |
|---|---|---|---|---|---|---|---|---|
| Component | 2 [wt. %] | 3 [wt. %] | 4 [wt. %] | 5 [wt. %] | 6 [wt. %] | 7 [wt. %] | 8 [wt. %] | 9 [wt. %) |
| Metallocene- | 40 | 40 | 30 | 40 | — | — | — | — |
| catalyzed | | | | | | | | |
| propylene | | | | | | | | |
| homopolymer | | | | | | | | |
| (MFI 60) | | | | | | | | |
| Metallocene- | — | — | — | — | 30 | 30 | — | — |
| catalyzed | | | | | | | | |
| propylene | | | | | | | | |
| homopolymer | | | | | | | | |
| (MFI 150) | | | | | | | | |
| Metallocene- | — | — | — | — | — | — | 65.8 | 31.8 |
| catalyzed | | | | | | | | |
| propylene | | | | | | | | |
| homopolymer | | | | | | | | |
| (MFI 25) | | | | | | | | |
| Highly crystalline | — | — | — | — | 20.2 | — | — | — |
| propylene | | | | | | | | |
| homopolymer | | | | | | | | |
| (MFI 5) | | | | | | | | |
| Highly crystalline | 27.2 | 27.2 | 37.2 | 26.7 | 17 | — | — | — |
| propylene | | | | | | | | |
| homopolymer | | | | | | | | |
| (MFI 20) | | | | | | | | |
| Propylene | — | — | — | — | — | 37.2 | — | — |
| Homopolymer | | | | | | | | |
| (MFI 12) | | | | | | | | |
| Propylene | — | — | — | — | — | — | — | 25 |
| Homopolymer | | | | | | | | |
| (MFI 1.8) | | | | | | | | |
| Glass Fibers (4 | 30 | 30 | 30 | 30 | 30 | 30 | 31.5 | 30 |
| mm) | | | | | | | | |
| Maleic Anhydride | 1.6 | 1.6 | 1.6 | 1.6 | 1.6 | 1.6 | 1 | 1.5 |
| functionalized | | | | | | | | |
| polypropylene | | | | | | | | |
| Black | 0.4 | 0.4 | 0.4 | 0.4 | 0.4 | 0.4 | 0.4 | — |
| polyethylene | | | | | | | | |
| masterbatch | | | | | | | | |
| Antioxidant 168 | 0.3 | — | 0.3 | 0.3 | 0.3 | — | 0.3 | 0.25 |
| Antioxidant 1010 | 0.3 | 0.3 | 0.3 | 0.3 | 0.3 | 0.3 | 0.3 | 0.25 |
| Thioester | — | 0.3 | — | — | — | 0.3 | — | — |
| Antioxidant | | | | | | | | |
| Polyethylene | 0.2 | 0.2 | 0.2 | 0.2 | 0.2 | 0.2 | 0.2 | 0.2 |
| Wax | | | | | | | | |
| Talc | — | — | — | 0.5 | — | — | 0.5 | — |
| White LLDPE | — | — | — | — | — | — | — | 11 |
| masterbatch | | | | | | | | |

Samples 2-8 were tested for their mechanical properties and emission characteristics, which are provided in Table 4.

TABLE 4

| | Test | | Sample | | | | | | |
|---|---|---|---|---|---|---|---|---|---|
| Characteristic | Method | Unit | 2 | 3 | 4 | 5 | 6 | 7 | 8 |
| Melt Flow Rate | ISO 1133 | g/10 | 13.9 | 13.9 | 10.8 | 13.7 | 10.8 | 12.3 | 9.5 |
| | (230° C.- | min | | | | | | | |
| | 2.16 kg) | | | | | | | | |
| Tensile | ISO 527 | MPa | 7290 | 7190 | 7270 | 7170 | 6780 | 6765 | 7009 |
| Modulus | | | | | | | | | |
| Tensile | ISO 527 | MPa | 88.8 | 87.7 | 90.5 | 89.7 | 89.5 | 85.2 | 82.5 |
| Strength at | | | | | | | | | |
| yield | | | | | | | | | |
| Elongation at | ISO 527 | % | — | — | 3.8 | 3.8 | 2.9 | — | 3.1 |
| yield | | | | | | | | | |
| Tensile | ISO 527 | MPa | 88.2 | 86.3 | 89.7 | 88.8 | 88 | 84.6 | 79.9 |
| Strength at | | | | | | | | | |
| break | | | | | | | | | |
| Elongation at | ISO 527 | % | 3 | 3.1 | 3 | 3 | 3.3 | 3 | 3.9 |
| break | | | | | | | | | |
| Flexural | ISO 178 | MPa | 6350 | 6375 | 6440 | 6250 | 6495 | 5982 | 6380 |
| Modulus | | | | | | | | | |
| Maximum | ISO 178 | MPa | 141 | 142.5 | 143 | 141 | 144 | 137 | 135 |
| Flexural Stress | | | | | | | | | |
| Izod Notched | ISO 180 | kJ/m² | 9.8 | 9.7 | 10.1 | 9.7 | 10.7 | 10.3 | — |
| Charpy | ISO | kJ/m² | 9.5 | 9.7 | 10.2 | 9.9 | 10 | 10.4 | 9.8 |
| Notched | 179/1eA | | | | | | | | |
| Charpy | ISO | kJ/m² | 49.3 | 50.1 | 50.8 | 52.8 | 54 | 54 | 54.7 |
| Unnotched | 179/1eU | | | | | | | | |
| HDT 1,8 | ISO 75 | ° C. | 142 | 141 | 144 | 141 | 143 | 141 | 140 |
| Fogging | DIN75201- | mg | 0.92 | 0.96 | 1.21 | — | 1.24 | — | — |
| | method B | | | | | | | | |

Samples 2, 3, 4, 6, and 8 were then aged at 150° C. for 1,000 hours and tested for their tensile properties, which are provided in Table 5. Table 5 also indicates whether the sample became brittle within 1,000 hours.

TABLE 5

| | Test | | | | | | |
|---|---|---|---|---|---|---|---|
| Characteristic | Method | Unit | 2 | 3 | 4 | 6 | 8 |
| Tensile Strength | ISO 527 | MPa | 95.6 | 95 | 94.5 | 94 | 23.7 |
| at break | | | | | | | |
| Elongation at | ISO 527 | % | 2.3 | 2.4 | 2.3 | 2.4 | 0.4 |
| break | | | | | | | |
| Time to Brittling | | h | over | over | over | over | before |
| | | | 1000 | 1000 | 1000 | 1000 | 1000 |

### Examples 10-17

Samples 10-17 were formed using metallocene catalyzed polypropylene homopolymers, glass fibers, compatibilizers, and various other components as indicated in Table 6. The glass fibers contained in Samples 10-17 had an average length of 3 mm and an average diameter of 13 μm. The samples were prepared in the same manner as described in Example 1.

TABLE 6

| | Sample | | | | | | | |
|---|---|---|---|---|---|---|---|---|
| | 10 | 11 | 12 | 13 | 14 | 15 | 16 | 17 |
| Component | [wt. %] | [wt. %] | [wt. %] | [wt. %] | [wt. %] | [wt. %] | [wt. %] | [wt. %] |
| Metallocene-catalyzed | 40 | 40 | 48 | 25.8 | — | — | — | — |
| propylene homopolymer | | | | | | | | |
| (MFI 60) | | | | | | | | |
| Metallocene-catalyzed | — | — | — | — | — | 50 | — | — |
| propylene homopolymer | | | | | | | | |
| (MFI 140) | | | | | | | | |
| Metallocene-catalyzed | — | — | — | 40 | 65.8 | — | 65.8 | 65.5 |
| propylene homopolymer | | | | | | | | |
| (MFI 25) | | | | | | | | |
| Propylene homopolymer | — | — | — | — | — | 15.8 | — | — |
| (MFI 0.9) | | | | | | | | |
| Highly crystalline | 27.2 | 27.8 | 17.8 | — | — | — | — | — |
| propylene homopolymer | | | | | | | | |
| (MFI 20) | | | | | | | | |
| Glass Fibers (3 mm) | 30 | 30 | 32 | 32 | 32 | 32 | 31.5 | 31.5 |
| Maleic Anhydride | 1.6 | 1 | 1 | 1 | 1 | 1 | 1 | 1 |
| functionalized | | | | | | | | |
| polypropylene | | | | | | | | |
| Black polyethylene | 0.4 | 0.4 | 0.4 | 0.4 | 0.4 | 0.4 | 0.4 | 0.4 |
| masterbatch | | | | | | | | |
| Antioxidant 168 | 0.3 | 0.3 | 0.3 | 0.3 | 0.3 | 0.3 | 0.3 | 0.3 |
| Antioxidant 1010 | 0.3 | 0.3 | 0.3 | 0.3 | 0.3 | 0.3 | 0.3 | 0.3 |
| Thioester Antioxidant | — | — | — | — | — | — | — | 0.3 |
| Polyethylene Wax | 0.2 | 0.2 | 0.2 | 0.2 | 0.2 | 0.2 | 0.2 | 0.2 |
| Talc | — | — | — | — | — | — | 0.5 | 0.5 |

Samples 10-17 were tested for their mechanical properties and emission characteristics, which are provided in Table 4.

TABLE 7

| | Test | | Sample | | | | | | | |
|---|---|---|---|---|---|---|---|---|---|---|
| Characteristic | Method | Unit | 10 | 11 | 12 | 13 | 14 | 15 | 16 | 17 |
| Melt Flow | ISO 1133 | g/10 | 12.8 | 12.9 | 13.7 | 13.4 | 10.3 | 14.5 | 8.3 | 8.7 |
| Rate | (230° C.- | min | | | | | | | | |
| | 2.16 kg) | | | | | | | | | |
| Tensile | ISO 527 | MPa | 6860 | 7270 | 7550 | 7447 | 7391 | 7636 | 7083 | 6855 |
| Modulus | | | | | | | | | | |
| Tensile | ISO 527 | MPa | 99.5 | 97 | 99.2 | — | — | — | 88.5 | 87 |
| Strength at | | | | | | | | | | |
| yield | | | | | | | | | | |
| Elongation at | ISO 527 | % | 2.9 | 2.8 | 2.8 | — | — | — | 3.2 | 3.4 |
| yield | | | | | | | | | | |
| Tensile | ISO 527 | MPa | 98.3 | 96.8 | 98.9 | 93.5 | 92.3 | 95.3 | 86.4 | 85.6 |
| Strength at | | | | | | | | | | |
| break | | | | | | | | | | |
| Elongation at | ISO 527 | % | 3 | 2.8 | 2.8 | 3.2 | 3.3 | 3.3 | 3.9 | 3.9 |
| break | | | | | | | | | | |
| Flexural | ISO 178 | MPa | 6488 | 6150 | 6760 | 6441 | 6320 | 6773 | 6684 | 6475 |
| Modulus | | | | | | | | | | |
| Maximum | ISO 178 | MPa | 153.9 | 147.5 | 154 | 142.9 | 142.2 | 150.8 | 145 | 141.9 |
| Flexural | | | | | | | | | | |
| Stress | | | | | | | | | | |
| Izod Notched | ISO 180 | kJ/m² | 12.8 | 12.9 | 10.9 | 11.5 | 12.3 | 11.6 | — | |
| Charpy | ISO | kJ/m² | 11.8 | 14.5 | 14.9 | 11,3 | 12 | 11.3 | 10.9 | 11 |
| Notched | 179/1eA | | | | | | | | | |
| Charpy | ISO | kJ/m² | 63.7 | 87.8 | 85 | 56.6 | 60.5 | 62.9 | 58.8 | 58.1 |
| Unnotched | 179/1eU | | | | | | | | | |
| HDT 1, 8 | ISO 75 | ° C. | 144 | 144 | 143 | 140 | 140 | 142 | 141 | 140 |
| Fogging | DIN75201- | mg | 0.87 | 0.72 | 0.61 | 0.28 | 0.15 | 0.23 | — | 0.18 |
| | method B | | | | | | | | | |

Samples 10, 12, and 14-17 were then aged at 150° C. for 1,000 hours and tested for their tensile properties, which are provided in Table 8. Table 8 also indicates whether the sample became brittle within 1,000 hours and if not, the time to brittling.

TABLE 8

| | Test | | | | | | | |
|---|---|---|---|---|---|---|---|---|
| Characteristic | Method | Unit | 10 | 12 | 14 | 15 | 16 | 17 |
| Tensile Modulus | ISO 527 | MPa | — | — | — | — | — | 7473 |
| Tensile Strength | ISO 527 | MPa | 103.6 | 100.7 | — | — | — | 93.4 |
| at break | | | | | | | | |
| Elongation at | ISO 527 | % | 2.3 | 1.9 | — | — | — | 2.6 |
| break | | | | | | | | |
| Time to Brittling | | h | over | over | 900 | 900 | 900 | over |
| | | | 1000 | 1000 | | | | 1000 |

### Examples 18-21

Samples 18-21 were formed using metallocene catalyzed polypropylene homopolymers, glass fibers, compatibilizers, and various other components as indicated in Table 9. The glass fibers contained in Samples 18-21 had an average length of 4 mm and an average diameter of 13 μm. The samples were prepared in the same manner as described in Example 1.

TABLE 9

| | Sample 18 | Sample 19 | Sample 20 | Sample 21 |
|---|---|---|---|---|
| Component | [wt. %] | [wt. %] | [wt. %] | [wt. %] |
| Metallocene-catalyzed | 32.8 | 32.3 | 42.3 | 41.8 |
| propylene homopolymer | | | | |
| (MFI 20) | | | | |
| Highly crystalline | 25 | 25 | — | — |
| propylene homopolymer | | | | |
| (MFI 5) | | | | |
| Propylene homopolymer | — | — | 15 | 15 |
| (MFI 0.9) | | | | |
| Glass Fibers | 40 | 40 | 40 | 40 |
| (4 mm) | | | | |
| Maleic Anhydride | 1 | 1 | 1 | 1.5 |
| functionalized | | | | |
| polypropylene | | | | |
| Black polyethylene | 0.4 | 0.4 | 0.4 | 0.4 |
| masterbatch | | | | |
| Antioxidant 168 | 0.3 | 0.3 | 0.3 | 0.3 |
| Antioxidant 1010 | 0.3 | 0.3 | 0.3 | 0.3 |
| Zeolite | — | 0.5 | 0.5 | 0.5 |
| Polyethylene Wax | 0.2 | 0.2 | 0.2 | 0.2 |

Samples 18-21 were tested for their mechanical properties and emission characteristics, which are provided in Table 10.

TABLE 10

| | | | Sample | Sample | Sample | Sample |
|---|---|---|---|---|---|---|
| Characteristic | Test Method | Unit | 18 | 19 | 20 | 21 |
| Melt Flow Rate | ISO 1133 (230° C.- | g/10 | 4.4 | 4.4 | 3.9 | 3.7 |
| | 2.16 kg) | min | | | | |
| Tensile Modulus | ISO 527 | MPa | 8671 | 8546 | 8509 | 8426 |
| Tensile Strength at | ISO 527 | MPa | 92.1 | 93.7 | 86.3 | 87.9 |
| yield | | | | | | |
| Elongation at yield | ISO 527 | % | | — | 2.7 | 2.9 |
| Tensile Strength at | ISO 527 | MPa | 90.7 | 92.9 | 82.5 | 85.5 |
| break | | | | | | |
| Elongation at break | ISO 527 | % | 3.1 | 3.1 | 3.2 | 3.7 |
| Flexural Modulus | ISO 178 | MPa | 8652 | 8727 | 7936 | 7882 |
| Maximum Flexural | ISO 178 | MPa | 153.4 | 155.2 | 142 | 144.9 |
| Stress | | | | | | |
| Izod Notched | ISO 180 | kJ/m² | 10.5 | 10.7 | 10.3 | 11 |
| Charpy Notched | ISO 179/1eA | kJ/m² | 10.3 | 10.8 | 10 | 10.6 |
| Charpy Unnotched | ISO 179/1eU | kJ/m² | 53.2 | 55 | 53.7 | 58.1 |
| HDT 1.8 | ISO 75 | ° C. | 145 | 146 | 139 | 140 |
| Fogging-gravimetric | DIN75201-method | mg | 1.88 | 1.19 | 0.17 | 0.17 |
| | B | | | | | |
| Odor-B3 (2 h at | VDA270 | — | 3.6 | 3 | — | — |
| 80° C.) | | | | | | |
| VOC | VDA277 | ug/g | 11 | 10 | — | — |
| TVOC | VDA 278 | ug/g | 92 | 64 | 9.78 | 9.14 |
| FOG | VDA 278 | ug/g | 260 | 206 | 19.65 | 20.23 |
| Fogging- | DIN75201-method | % | 72.7 | 49.98 | 71.79 | 72.78 |
| reflectometric | A | | | | | |

Samples 18, 19, and 21 were then aged at 150° C. for 1,000 hours and tested for their tensile properties, which are provided in Table 11. After performing the tensile tests, the samples were aged until they became brittle. The results of these tensile tests and the time to brittling are provided in Table 11.

TABLE 11

| | Test | | | | |
|---|---|---|---|---|---|
| Characteristic | Method | Unit | Sample 18 | Sample 19 | Sample 21 |
| Tensile Modulus | ISO 527 | MPa | 10302 | 10084 | — |
| Tensile Strength at | ISO 527 | MPa | 101.8 | 105.1 | — |
| break | | | | | |
| Elongation at break | ISO 527 | % | 1.9 | 2.1 | — |
| Time to Brittling | | h | 1288 | 1408 | 616 |

### Examples 22-25

Samples 22-25 were formed using metallocene catalyzed polypropylene homopolymers, glass fibers, compatibilizers, and various other components as indicated in Table 12. The glass fibers contained in Samples 22-25 had an average length of 3 mm and an average diameter of 13 μm. The samples were prepared in the same manner as described in Example 1.

TABLE 12

| | Sample 22 | Sample 23 | Sample 24 | Sample 25 |
|---|---|---|---|---|
| Component | [wt. %] | [wt. %] | [wt. %] | [wt. %] |
| Metallocene-catalyzed | 41.8 | 41 | — | — |
| propylene homopolymer | | | | |
| (MFI 20) | | | | |
| Metallocene-catalyzed | — | — | 41 | 36 |
| propylene homopolymer | | | | |
| (MFI 25) | | | | |
| Highly crystalline | — | — | — | 10 |
| propylene homopolymer | | | | |
| (MFI 5) | | | | |
| Propylene homopolymer | 15 | 15 | 15 | 10 |
| (MFI 0.9) | | | | |
| Glass Fibers | 40 | 40 | 40 | 40 |
| (4 mm) | | | | |
| Maleic Anhydride | 1.5 | 1.5 | 1.5 | 1.5 |
| functionalized | | | | |
| polypropylene | | | | |
| Black polyethylene | 0.4 | 0.4 | 0.4 | 0.4 |
| masterbatch | | | | |
| Antioxidant 168 | 0.3 | 0.3 | 0.3 | 0.3 |
| Antioxidant 1010 | 0.3 | 0.3 | 0.3 | 0.3 |
| Thioester Antioxidant | — | 0.3 | 0.3 | 0.3 |
| Zeolite | 0.5 | 0.5 | 0.5 | 0.5 |
| Polyethylene Wax | 0.2 | 0.2 | 0.2 | 0.2 |
| Talc | — | 0.5 | 0.5 | 0.5 |

Samples 22-25 were tested for their mechanical properties and emission characteristics, which are provided in Table 13.

TABLE 13

| | | | Sample | Sample | Sample | Sample |
|---|---|---|---|---|---|---|
| Characteristic | Test Method | Unit | 22 | 23 | 24 | 25 |
| Melt Flow Rate | ISO 1133 (230° C.- | g/10 | 2.6 | 3 | 3.4 | 3.4 |
| | 2.16 kg) | min | | | | |
| Tensile Modulus | ISO 527 | MPa | 7871 | 9238 | 9222 | 9408 |
| Tensile Strength at | ISO 527 | MPa | 97.1 | 96.5 | 95.9 | 99.6 |
| yield | | | | | | |
| Tensile Strength at | ISO 527 | MPa | 96.3 | 95.4 | 94.6 | 98.6 |
| break | | | | | | |
| Elongation at break | ISO 527 | % | 3.3 | 3.4 | 3.5 | 3.2 |
| Flexural Modulus | ISO 178 | MPa | 8366 | 8941 | 8958 | 9184 |
| Maximum Flexural | ISO 178 | MPa | 157.9 | 160 | 159 | 164 |
| Stress | | | | | | |
| Izod Notched | ISO 180 | kJ/m² | 13.2 | — | — | — |
| Charpy Notched | ISO 179/1eA | kJ/m² | 12.7 | 12.3 | 12.1 | 12.3 |
| Charpy Unnotched | ISO 179/1eU | kJ/m² | 64.2 | 66.3 | 60.5 | 60.7 |
| HDT 1.8 | ISO 75 | ° C. | 141 | 142 | 143 | 145 |
| Fogging-gravimetric | DIN75201-method | mg | 0.09 | 0.08 | 0.14 | 0.21 |
| | B | | | | | |
| Odor-B3 (2 h at | VDA270 | | — | 2.5 | 2.5 | 2.5 |
| 80° C.) | | | | | | |
| VOC | VDA277 | ug/g | — | 6.40 | 6.60 | 9.10 |
| TVOC | VDA 278 | ug/g | 9.86 | 12.30 | 9.50 | 26.40 |
| FOG | VDA 278 | ug/g | 17.71 | 66.50 | 42.20 | 111.40 |
| Fogging- | DIN75201-method | % | 72.36 | 100.09 | 99.69 | 100.40 |
| reflectometric | A | | | | | |

Samples 22 was aged at 150° C. and became brittle after 640 hours. Samples 23, 24, and 25 were then aged at 150° C. for 1,000 hours and tested for their tensile properties, which are provided in Table 14. After performing the tensile tests, the samples were aged until they became brittle. The results of these tensile tests and the time to brittling are provided in Table 14.

TABLE 14

| | Test | | | | |
|---|---|---|---|---|---|
| Characteristic | Method | Unit | Sample 23 | Sample 24 | Sample 25 |
| Tensile Modulus | ISO 527 | MPa | 10138 | 10292 | 10328 |
| Tensile Strength at | ISO 527 | MPa | 105.2 | 103.2 | 105.9 |
| break | | | | | |
| Elongation at break | ISO 527 | % | 2.3 | 2.2 | 2 |
| Time to Brittling | | h | 1500 | 1912 | 1836 |

What is claimed is:

1. A propylene polymer composition comprising:
a metallocene-catalyzed propylene homopolymer;
from about 20 to about 60 wt. % glass fibers having an average fiber length of about 4.5 mm or less; and
a compatibilizer comprising a functionalized polyolefin;
wherein the propylene polymer composition exhibits a fogging value of about 0.6 mg or less as determined by DIN 75201:2011 (method B) and a flexural modulus of about 4000 MPa or more as determined at a temperature of about 23° C. by ISO 527:2019.

2. The propylene polymer composition of claim 1, wherein the metallocene-catalyzed propylene homopolymer has a melt flow rate from about 50 g/10 min or less as determined by ISO 1133-1:2011 under 2.16 kg and at 230° C.

3. The propylene polymer composition of claim 2, further comprising a second propylene homopolymer having a melt flow rate from about 55 g/10 min or more as determined by ISO 1133-1:2011 under 2.16 kg and at 230° C.

4. The propylene polymer composition of claim 3, wherein the ratio of propylene homopolymers having a melt flow rate of 50 g/10 min or less to propylene homopolymers having a melt flow rate of 55 g/10 min or more is from about 1:5 to about 5:1.

5. The propylene polymer composition of claim 1, wherein the metallocene-catalyzed propylene homopolymer has a melt flow rate from about 15 to about 200 g/10 min as determined by ISO 1133-1:2011 under 2.16 kg and at 230° C.

6. The propylene polymer composition of claim 5, further comprising a second propylene homopolymer having a melt flow rate from about 0.5 to about 2 g/10 min as determined by ISO 1133-1:2011 under 2.16 kg and at 230° C.

7. The propylene polymer composition of claim 6, wherein the ratio of propylene homopolymers having a melt flow rate from 15 to 200 g/10 min to propylene homopolymers having a melt flow rate from 0.5 to 2 g/10 min is from about 2:1 to about 4:1.

8. The propylene polymer composition of claim 1, wherein non-metallocene-catalyzed propylene homopolymers constitute no more than about 20 wt. % of the polymer composition.

9. The propylene polymer composition of claim 1, wherein non-metallocene-catalyzed propylene polymers having a crystallinity of about 70% or greater as determined by DSC constitute no more than about 15 wt. % of the polymer composition.

10. The propylene polymer composition of claim 9, wherein the composition is free of non-metallocene-catalyzed propylene polymers.

11. The propylene polymer composition of claim 1, wherein the composition exhibits a FOG value of about 500 μg/g or less as determined by VDA 278:2002.

12. The propylene polymer composition of claim 1, wherein the composition exhibits a TVOC value of about 100 μg/g or less as determined by VDA 278:2002.

13. The propylene polymer composition of claim 1, wherein the composition exhibits a heat deflection temperature of about 100° C. or more as determined by ISO 75-2:2013.

14. The propylene polymer composition of claim 1, wherein the composition exhibits a Charpy notched impact strength of about 2 kJ/m² or more as determined by ISO 179-1:2010 at 23° C.

15. The propylene polymer composition of claim 1, wherein the composition exhibits a tensile modulus of about 2,000 MPa or more as determined by ISO 527-1:2019 at 23° C.

16. The propylene polymer composition of claim 1, wherein the composition exhibits a tensile strength at yield of about 25 MPa or more as determined by ISO 527-1:2019 at 23° C.

17. The propylene polymer composition of claim 1 wherein the compatibilizer comprises a maleic anhydride modified polypropylene.

18. The propylene polymer composition of claim 1, wherein the composition has a melt flow rate of about 50 g/10 min or less as determined by ISO 1133-1:2011 under 2.16 kg and at 230° C.

19. The propylene polymer composition of claim 1, wherein polypropylene homopolymers constitute from about 20 to about 80 wt. % of the composition.

20. The propylene polymer composition of claim 1, wherein the compatibilizer constitutes from about 0.5 to about 15 wt. % of the composition.

21. The propylene polymer composition of claim 1, wherein the glass fibers have an average cross-sectional diameter from about 5 to about 25 μm.

22. The propylene polymer composition of claim 1, wherein the composition exhibits a Charpy unnotched impact strength of about 10 kJ/m² or greater as determined at 23° C. according to ISO Test No. 179-1:2010.

23. The propylene polymer composition of claim 1, wherein the composition exhibits a total volatile content (“VOC”) of about 50 μgC/g or less as determined in accordance with VDA 277:1995.

24. The propylene polymer composition of claim 1, wherein the composition exhibits an elongation at break of about 1% or more as determined by ISO 527-1:2019.

25. An automotive part comprising the propylene polymer composition of claim 1.

26. The automotive part of claim 25, wherein the automotive part comprises a headlamp housing.
